(19) United States
(12) Patent Application Publication
(10) Pub. No.: US 2014/0062990 A1
(43) Pub. Date: Mar. 6, 2014

(54) CIRCUIT AND METHOD FOR COMPENSATING COMMON VOLTAGE AND LIQUID CRYSTAL DISPLAY APPARATUS

(71) Applicants: Beijing BOE Display Technology Co., Ltd., Beijing (CN); BOE TECHNOLOGY GROUP CO., LTD., Beijing (CN)

(72) Inventor: Chunbing ZHANG, Beijing (CN)

(73) Assignees: Beijing BOE Display Technology Co., Ltd., Beijing (CN); BOE TECHNOLOGY GROUP CO., LTD., Beijing (CN)

(21) Appl. No.: 14/014,914

(22) Filed: Aug. 30, 2013

(30) Foreign Application Priority Data
Aug. 31, 2012 (CN) 201210320829.0

(51) Int. Cl. G09G 3/36; G05F 1/10

(52) U.S. Cl. CPC G09G 3/3696; G05F 1/10
USPC 345/212; 323/234; 345/87

(57) ABSTRACT

The present invention relates to a field of display technique. It is provided a circuit and method for compensating a common voltage and a liquid crystal display apparatus, which have a high accuracy in compensation, may acquire a more stable common voltage, avoid phenomena such as a residual image, the abnormality of displaying gray scales, a crosstalk and the like caused by a shift of the common voltage, and raise the display effect. The method for compensating the common voltage according to the embodiments of the present invention comprises: comparing a feedback voltage with a reference common voltage output from a common voltage generation circuit and outputting a compared result; generating a compensation control signal according to the compared result; and compensating the common voltage according to the compensation control signal. The common voltage compensation circuit comprises: a comparison unit, a logic unit and a compensation unit.

### FIELD OF THE INVENTION

The present disclosure relates to a field of displaying, and in particular, to a circuit and method for compensating a common voltage and a liquid crystal display apparatus.

### BACKGROUND

The liquid crystal display apparatus has been applied widely to electronic equipments such as a display, a TV, a mobile phone, a digital photo frame, etc. because of its special advantages of light weight, small volume, low power consumption and low radiation, etc.

The liquid crystal display apparatus exerts a driving voltage difference on a liquid crystal layer disposed between pixel electrodes and common electrodes by using the pixel electrodes and the common electrodes, thereby making liquid crystal molecules in the liquid crystal layer rotated, and controlling a transmittance of light so as to display pictures. The driving voltage difference is determined relative to a potential (a common voltage) applied to the common electrode, and thus a stable common voltage is required to drive the liquid crystal display. However, a phenomenon of shifting of the common voltage often occurs due to a capacitor coupling inside the liquid crystal display apparatus, which leads to an increase or decrease in the common voltage. As a result, phenomena such as a residual image, the abnormality of displaying gray scales, a crosstalk and the like occur and the display effect is affected.

In order to settle the above problems, there generally adopts in the prior art a manner of performing a feedback compensation to the common voltage to obtain a stable common voltage. A concrete implementation is as follows: a liquid crystal panel comprises a plurality of coupling elements connected between data lines and pixel electrodes, the coupling element generates a coupling signal according to a display signal received by the pixel electrode and applies the same to the data line; the coupling signal is transferred via the data line to a synchronous filter circuit to be filtered, and is input to a common voltage compensation circuit as shown in FIG. 1 as a feedback signal after data signals are filtered; inside the common voltage compensation circuit, the feedback signal is filtered by a filtering capacitor 101 to isolate direct current components in the feedback signal, and then subjects to an operation through a negative feedback of an operational amplifier 102, that is, the filtered feedback signal is compared with a reference common voltage Vref, and then the reference common voltage Vref is compensated according to the result of comparison, so that a compensated common voltage signal is outputted, and finally is outputted to a common line and the common electrode after being power-amplified by an emitter output device 105 composed of transistors. Additionally, elements 103, 104 illustrated in FIG. 1 are resistors.

Inventors found that the above common voltage compensation circuit is implemented mostly with analog circuits, but it is easy for the analog circuits to generate certain drifts when environment changes, which may cause precision of the circuits to be deceased, such that the common voltage compensation circuit fails to accurately compensate and adjust the common voltage, and the display effect is affected.

### SUMMARY

The present invention is to provide a circuit and method for compensating a common voltage and a liquid crystal display apparatus, which have a high accuracy in compensation, may acquire a more stable common voltage, avoid phenomena such as a residual image, the abnormality of displaying gray scales, a crosstalk and the like caused by a shift of the common voltage, and raise the display effect.

To achieve the above objects, embodiments of the present invention employ following solutions.

A method for compensating a common voltage, comprising steps of:

comparing a feedback voltage with a reference common voltage outputted from a common voltage generation circuit and outputting a compared result, the feedback voltage being a common voltage acquired actually at a common electrode;

generating and outputting a compensation control signal according to the compared result;

compensating the common voltage according to the compensation control signal.

Optionally, the step of generating a compensation control signal according to the result of comparison further comprises:

generating the compensation control signal for providing a first level signal to the common electrode when a deviation of the feedback voltage from the reference common voltage exceeds a preset lower limit voltage value; and generating the compensation control signal for providing a second level signal to the common electrode when the deviation of the feedback voltage from the reference common voltage exceeds a preset upper limit voltage value, wherein the first level signal is greater than the reference common voltage, and the second level signal is smaller than the reference common voltage.

Optionally, the step of compensating the common voltage according to the compensation control signal comprises:

connecting the common electrode to the first level signal or the second level signal according to the compensation control signal, the common electrode is charged such that the common voltage increases when the common electrode is connected to the first level signal, and the common electrode is discharged such that the common voltage decreases when the common electrode is connected to the second level signal.

The embodiments of the present invention further provide a circuit for compensating a common voltage, comprising two input terminals and one output terminal, the input terminals are connected with a common voltage generation circuit and a common electrode disposed on a liquid crystal panel, respectively, and the output terminal is also connected with the common electrode, the common voltage compensation circuit comprises:

a comparison unit for receiving a feedback voltage and a reference common voltage output from the common voltage generation circuit, comparing the feedback voltage with the reference common voltage and outputting a compared result, the feedback voltage being a common voltage acquired at a common electrode actually;

a logic unit for generating and outputting a compensation control signal according to the result of comparison;

a compensation unit for receiving the compensation control signal output from the logic unit, and compensating the common voltage according to the compensation control signal.

The logic unit is particularly used to generate the compensation control signal for providing a first level signal to the common electrode when a deviation of the feedback voltage from the reference common voltage exceeds a preset lower limit voltage value; and generate the compensation control signal for providing a second level signal to the common electrode when the deviation of the feedback voltage from the reference common voltage exceeds a preset upper limit voltage value, wherein the first level signal is greater than the reference common voltage, and the second level signal is smaller than the reference common voltage.

The compensation unit is particularly used to connect the common electrode to the first level signal or the second level signal according to the compensation control signal, the common electrode is charged such that the common voltage increases when the common electrode is connected to the first level signal, and the common electrode is discharged such that the common voltage decreases when the common electrode is connected to the second level signal. Optionally, the comparison unit comprises a window comparator or a basic comparator.

Optionally, the compensation unit is a data selector configured to have at least two input terminals, one output terminal and one control terminal;

One of the at least two input terminals is used to input the first level signal, and the other is used to input the second level signal, the output terminal is connected with the common electrode, and the control terminal is connected with the logic unit.

Optionally, the compensation unit is a single-pole double throw electromagnetic relay configured to have two unmovable terminals, one movable terminal and one control signal input terminal.

One of the two unmovable terminals is used to input the first level signal, and the other is used to input the second level signal, the movable terminal is connected with the common electrode, and the control signal input terminal is connected with the logic unit.

Optionally, the compensation unit comprises:

a N-type field effect transistor and a P-type field effect transistor forming a complementary symmetry structure.

the gates of the N-type field effect transistor and the P-type field effect transistor are both connected with the logic unit, an input terminal of one of the N-type field effect transistor and the P-type field effect transistor is used to input the first level signal, an input terminal of the other is input the second level signal, and output terminals of the N-type field effect transistor and the P-type field effect transistor are both connected with the common electrode

Optionally, the compensation control signal is any one of a first control signal, a second control signal and a third control signal.

A voltage of the first control signal is higher than the first level signal, a voltage of the second control signal is lower than the first level signal, a voltage of the third control signal is greater than a difference between the reference common voltage and a threshold voltage of the field effect transistor and is smaller than the sum of the reference common voltage and the threshold voltage of the field effect transistor, and the threshold voltage of the field effect transistor is a smaller one of those in the N-type field effect transistor and the P-type field effect transistor.

The embodiments of the present invention further provide a display apparatus comprising any one of the described above common voltage compensation circuit.

The circuit and method for compensating the common voltage and the liquid crystal display apparatus provided in the embodiments of the present invention compare a common voltage acquired at a common electrode (a feedback voltage) actually with a reference common voltage outputted from a common voltage generation circuit, generate a compensation control signal according to a compared result, and then compensate the common voltage at the common electrode inside a liquid crystal panel according to the generated compensation control signal. In particular, the common electrode is connected to the first level signal when a deviation of the feedback voltage from the reference common voltage exceeds the preset lower limit voltage value, and the common electrode is charged such that the common voltage at the common electrode increases; and the common electrode is connected to the second level signal when the deviation of the feedback voltage from the reference common voltage exceeds a preset upper limit voltage value and the common electrode is discharged such that the common voltage at the common electrode decreases until the common voltage signal generating a shift recovers a balance. Finally, the liquid crystal panel obtains a stable common voltage internally, which settles the phenomena such as the residual image, the abnormality of displaying gray scales and the crosstalk and the like caused by the shift of the common voltage, so that the display effect of the liquid crystal display apparatus is raised.

In the prior art, the coupling signal generated by the capacitor coupling has to be filtered at first and then input to the compensation circuit as the feedback signal, only by this way interferences to one terminal of the capacitor by other electromagnetic wave can be filtered and signal-to-noise ratio can be reduced. Otherwise, the coupling signal would always include an output component generated by the noise. As compared, the embodiments of the present invention directly make the common voltage acquired actually at the common electrode as a feedback signal (the feedback voltage), compares the feedback signal with the reference common voltage, and generates the compensation control signal according to the result of the comparison to control whether the common electrode is connected or not and is connected to the first level signal or the second level signal, so as to control the charging and discharging of the common electrode to obtain the stable common voltage. It can be seen from the implementation process that, as compared with the prior art, the comparison (or detection) process is separated from the compensation process in the embodiments of the present invention, and thus the interferences to the one terminal of the capacitor by other electromagnetic wave can not affect the compensation process, which suppresses the interferences of signals, and no filtering processing is required for the feedback signal in the compensation circuit and method according to the embodiments of the present invention. Furthermore, the compensation circuit and method according to the embodiments of the present invention control the compensation unit by the compensation control signal to compensate the common voltage, have a higher compensation accuracy than existing compensation circuit, thereby it can compensate and adjust the common voltage more accurately and improve the display effect, which settles the technical problem of decrease in circuit accuracy caused by adopting the analog circuits in the existing compensation circuit.

### BRIEF DESCRIPTION OF THE DRAWINGS

FIG. 1 is a schematic diagram illustrating a structure of a common voltage compensation circuit of the prior art;

FIG. 2 is a flowchart of a method for compensating a common voltage according to embodiments of the present invention;

FIG. 3 is a schematic diagram illustrating a structure of a circuit for compensating a common voltage according to the embodiments of the present invention;

FIG. 4 is the first specific embodiment of a compensation unit in the common voltage compensation circuit according to the embodiments of the present invention;

FIG. 5 is the second specific embodiment of the compensation unit in the common voltage compensation circuit according to the embodiments of the present invention;

FIG. 6 is the third specific embodiment of the compensation unit in the common voltage compensation circuit according to the embodiments of the present invention.

Reference numerals of the figures: 101-capacitor, 102-operational amplifier, 103-emitter output device, 104-resister, 105-resister, 11-common electrode, 11a-input terminal of common electrode, 11b-feedback output terminal of common electrode, 2-common voltage generation circuit, 3-common voltage compensation circuit, 31-comparison unit, 32-logic unit, 33-compensation unit.

### DETAILED DESCRIPTION

The embodiments of the present invention provide a circuit and method for compensating a common voltage and a liquid crystal display apparatus, which have a high accuracy in compensation, may acquire a more stable common voltage, avoid phenomena such as a residual image, the abnormality of displaying gray scales, a crosstalk and the like caused by a shift of the common voltage, and enhance the display effect.

The embodiments of the present disclosure will be described below in further details in connection with drawings. The specific implementations described herein are only for explaining the present invention but not for limiting the present invention.

### First Embodiment

The embodiment of the present invention provides a method for compensating a common voltage, as illustrated in FIG. 2, the method for compensating a common voltage performs the following processes.

In step 201, comparing a feedback signal with a reference common voltage value Vref output from a common voltage generation circuit and outputting a result of the comparison, the feedback signal is a common voltage acquired actually at a common electrode.

A liquid crystal display apparatus comprises: a liquid crystal panel and a common voltage generation circuit, a common electrode is disposed on the liquid crystal panel, one terminal of the common electrode is connected with the common voltage generation circuit as an input terminal, the other terminal of the common electrode is as a feedback terminal, at which a common voltage acquired actually at the common electrode is output as a feedback voltage for controlling compensation. The feedback voltage (that is, the common voltage acquired actually) at the common electrode is compared with a reference common voltage value Vref, and the result of the comparison comprises three cases: (1) when a deviation of the feedback voltage, namely the common voltage acquired actually at the common electrode from the reference common voltage Vref exceeds a preset lower limit voltage value, the common voltage acquired actually at the common electrode is too low, a shift amount of the common voltage cannot be ignored, and the common voltage is required to be compensated so as to be pulled up, otherwise the kickbacks described in the BACKGROUND may occur; (2) when the deviation of the feedback voltage from the reference common voltage Vref exceeds a preset upper limit voltage value, the common voltage acquired actually at the common electrode is too high, the shift amount cannot be ignored, and the common voltage is required to be compensated so as to be decreased, otherwise the kickbacks described in the BACKGROUND may also occur; (3) when the deviation of the feedback voltage from the reference common voltage Vref neither exceeds the preset upper limit voltage value nor exceeds the preset lower limit voltage, that is, it is within a preset scope, the shift amount of the common voltage is ignorable and no compensation is required.

In step 202, generating and outputting a compensation control signal according to the result of the comparison.

In this step, generating the compensation control signal for providing a first level signal to the common electrode when the deviation of the feedback voltage from the reference common voltage Vref exceeds the preset lower limit voltage value, and generating the compensation control signal for providing a second level signal to the common electrode when the deviation of the feedback voltage from the reference common voltage Vref exceeds a preset upper limit voltage value, wherein the first level signal is greater than the reference common voltage Vref, and the second level signal is smaller than the reference common voltage Vref.

In particular, three compensation control signals may be generated correspondingly according to the result of the comparison in this step, in other words, the generated compensation control signal is one of three possible states, and the three possible states represent respectively: the common electrode is connected with a first level signal; the common electrode is connected with a second level signal; neither is connected with. For example, optionally, the three compensation control signals may be a high level (for example, the level of 1), a low level (for example, the level of −1) and a zero level.

Optionally, if the result of the comparison in the step 201 is the third case, two compensation control signals may be generated in the step 202 at this time, because no compensation is required, namely, the subsequent compensation action may be not needed to be performed. That is to say, the compensation control signal may be one of two possible states, and the two possible states represent respectively: the common electrode is connected with a first level signal and the common electrode is connected with a second level signal.

In step 203, compensating the common voltage according to the compensation control signal.

In particular, in this step, the common electrode is connected with the first level signal or the second level signal according to the compensation control signal, wherein the common electrode is charged so that the common voltage increases when the common electrode is connected to the first level signal, and the common electrode is discharged so that the common voltage decreases when the common electrode is connected to the second level signal.

In this step, a preset scope defined by the reference common voltage Vref, the preset lower limit voltage value and the preset upper limit voltage value is preset for the common voltage acquired actually at the common electrode (hereinafter referred to briefly as actual common voltage, and as feedback voltage or feedback signal after being input into the compensation circuit). If the actual common voltage is within the scope, no compensation is required; if the actual common voltage goes beyond the scope, the compensation is performed until the actual common voltage returns back to the preset scope. Thus, it achieves the object of stabilizing the common voltage inside the liquid crystal panel, avoids phenomena such as a residual image, the abnormality of displaying gray scales, a crosstalk and the like caused by the shift of the common voltage, and improves the display effect of the liquid crystal display apparatus.

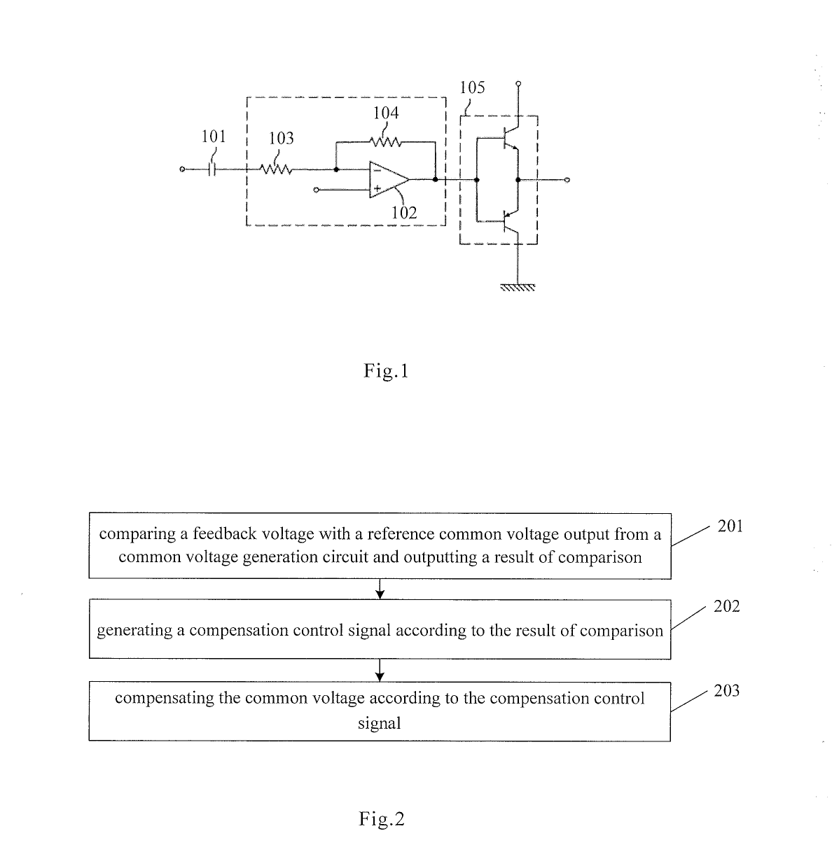

As compared with the prior art illustrated in FIG. 1, in the compensation method according to the embodiments of the present invention, the feedback signal (feedback voltage) is only used to generate the compensation control signal, the detection process is separated from the compensation process, so that the interferences to the one terminal of the capacitor by other electromagnetic wave can not affect the compensation process, which suppresses the interferences of signals, and no filtering process is required for the feedback signal. Furthermore, the method according to the embodiments of the present invention avoids the decrease in circuit accuracy caused by adopting the analog circuits in the prior art, increases the compensation accuracy, and may compensate and adjust the common voltage more accurately, thereby further raising the display effect.

### Second Embodiment

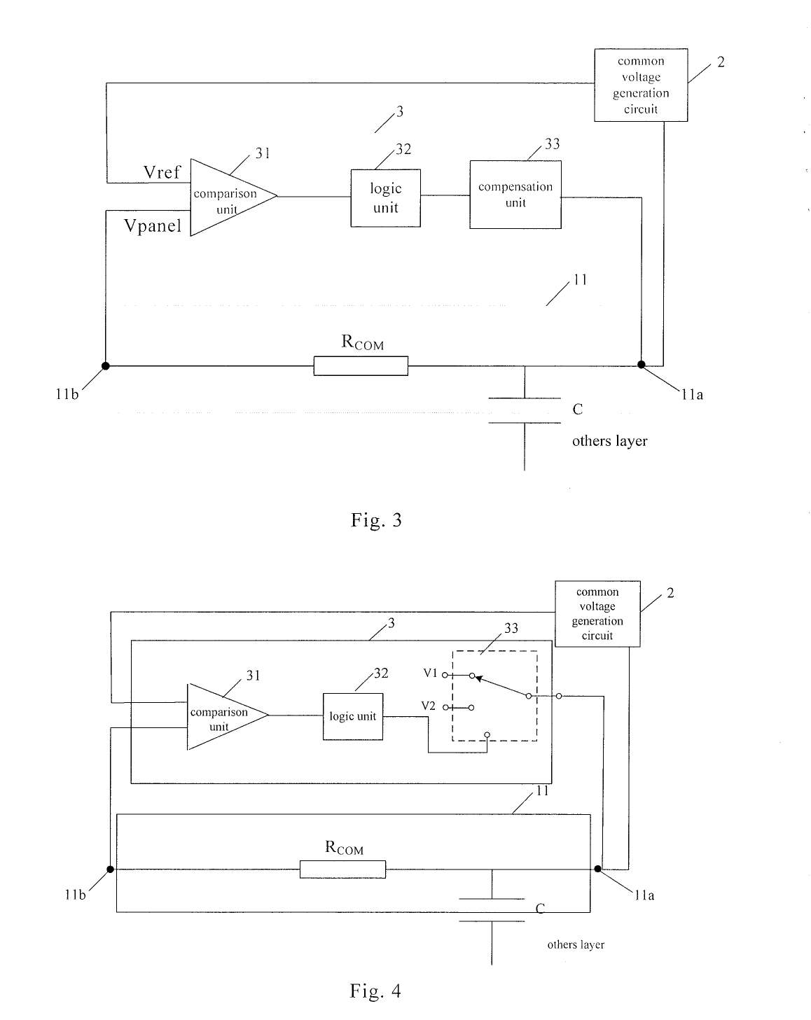

FIG. 3 shows a schematic diagram of a structure of the circuit for compensating a common voltage according to the embodiments of the present invention. As illustrated in FIG. 3, the circuit 3 for compensating a common voltage is configured to have two input terminals and one output terminal, the input terminals are connected with a common voltage generation circuit 2 and a common electrode 11 disposed on a liquid crystal panel, respectively, and the output terminal is also connected with the common electrode 11, the circuit 3 for compensating a common voltage comprises:

a comparison unit 31 for receiving a feedback voltage Vpanel and a reference common voltage Vref output from the common voltage generation circuit 2, comparing the feedback voltage Vpanel with the reference common voltage Vref and outputting a result of the comparison, the feedback voltage Vpanel is a common voltage acquired actually at the common electrode 11;

a logic unit 32 for generating a compensation control signal according to the result of the comparison output from the comparison unit 31;

In particular, the logic unit 32 generates the compensation control signal for providing a first level signal V1 to the common electrode 11 when a deviation of the feedback voltage Vpanel from the reference common voltage Vref exceeds a preset lower limit voltage value, and generates the compensation control signal for providing a second level signal V2 to the common electrode 11 when the deviation of the feedback voltage Vpanel from the reference common voltage Vref exceeds a preset upper limit voltage value, wherein the first level signal V1 is greater than the reference common voltage Vref, and the second level signal V2 is smaller than the reference common voltage Vref;

a compensation unit 33 for receiving the compensation control signal output from the logic unit 32, and compensating the common voltage according to the compensation control signal.

In particular, the common electrode 11 is connected with the first level signal V1 or the second level signal V2 according to the compensation control signal, the common electrode 11 is charged so that the common voltage increases when the common electrode 11 is connected to the first level signal V1, and the common electrode 11 is discharged so that the common voltage decreases when the common electrode 11 is connected to the second level signal V2.

The circuit 3 for compensating a common voltage is disposed in the liquid crystal apparatus, and the liquid crystal apparatus comprises: a liquid crystal panel and a common voltage generation circuit 2, the common electrode 11 is disposed on the liquid crystal panel, one terminal of the common electrode 11, which is connected with the common voltage generation circuit 2, is as an input terminal 11a, and the other terminal of the common electrode is as a feedback output terminal 11b which is connected with the common voltage compensation circuit 3, wherein common electrode lines inside the liquid crystal panel may be equivalent to a resistor R_{COM}, and an equivalent capacitor C exists between a common electrode layer and other metal layers.

Wherein the comparison unit 31 is used to monitor the common voltage acquired actually at the common electrode, and output signal representing three or two types of results of the comparison to the logic unit 32 by judging a case of the actual common voltage (that is, the feedback voltage) deviating from the reference common voltage value Vref. The three results of the comparison include: the deviation of the actual common voltage from the reference common voltage value Vref exceeds the preset lower limit voltage value, exceeds the preset upper limit voltage value, and neither exceeds the preset lower limit voltage value nor exceeds the preset upper limit voltage value, wherein the third result of the comparison requires no compensation and may not be output.

The configuration of the comparison unit 31 may be defined freely, for example, the comparison unit 31 is optically a window comparator or a basic comparator, but is not limited to these two kinds of comparators.

The window comparator may set the upper limit voltage value and the lower limit voltage value of the deviation, which are used to detect whether the common voltage that is fed back (feedback voltage) exceeds the set upper or lower limit voltage value, if it exceeds, the comparator outputs one state, for example, a level of 0; if it does not exceed, the comparator outputs another state, for example, a level of 1, to provide an enable signal to the logic unit.

The basic comparator is used to compare the magnitude of the common voltage that is fed back with the reference common voltage value, when it is detected that the common voltage that is fed back is higher than the reference common voltage, the comparator outputs one state, for example, a level of 1; if not exceeding, the comparator outputs another state, for example, a level of −1.

If it needs to further stabilize the actual common voltage within a preset scope (defined by the reference common voltage, the preset lower limit voltage value and the preset upper limit voltage value), optionally, two basic comparators and other elements (such as, transformer and the like) may be used to implement the solution. This is the common knowledge in the art and details are omitted.

The logic unit 32 receives signals representing results of the comparison (for example, maybe a digital signal: 1, −1 and 0) output from the comparison unit 31, and generates according to these signals (or converts these signals into) the compensation control signal for controlling the compensation unit 33, and thus the structure of the logic unit 32 and the generated compensation control signal are related to the specific structure of the compensation unit 33. Furthermore, the compensation control signal generally comprises three types (a pulling-up compensation, a pulling-down compensation and no compensation), and those skilled in the art may select the logic unit 32 arbitrarily thereby the present embodiment is not limited thereto.

Optionally, the comparison unit 31 and the logic unit 32 may be also integrated together and directly output the compensation control signal for controlling the compensation unit 33.

The compensation unit 33 controls the common electrode according to the compensation control signal output from the logic unit 32, and determines whether it is connected and whether it is connected to the first level signal or the second level signal, so as to stabilize the common voltage.

FIG. 4 is the first specific embodiment of a compensation unit in the common voltage compensation circuit according to the embodiments of the present invention. As shown in FIG. 4, the compensation unit 33 is a data selector on which at least two input terminals, one output terminal and one control terminal are disposed.

One of the at least two input terminals is input the first level signal V1, and the other one is input the second level signal V2, the output terminal is connected with the common electrode 11, and the control terminal is connected with the logic unit 32.

The data selector, which is also referred to as a “multiplex switch”, is a mature module in the prior art and comprises the types of one from two, one from four, one from eight, and one from sixteen, etc. In the present embodiment, the function of selecting one from two may be implemented by utilizing an one from two data selector (MUX21), or connecting several input terminals of an one from multiple data selector (such as an one from eight MUX81) with each other. Therefore, the data selector in the present embodiment may be a chip such as familiar 74LS151, T580, 74SL153 and the like. The data selector also may be controlled to connect to the first level signal V1 or the second level signal V2 through a relay depending on actual requirements.

The compensation unit 33 implemented by the data selector selects to output the first level signal V1 or the second level signal V2 according to the compensation control signal of the logic unit 32 so as to obtain a stable common voltage. The specific operation manner of the entire circuit is substantively similar to that of the Second Embodiment, and the details are omitted.

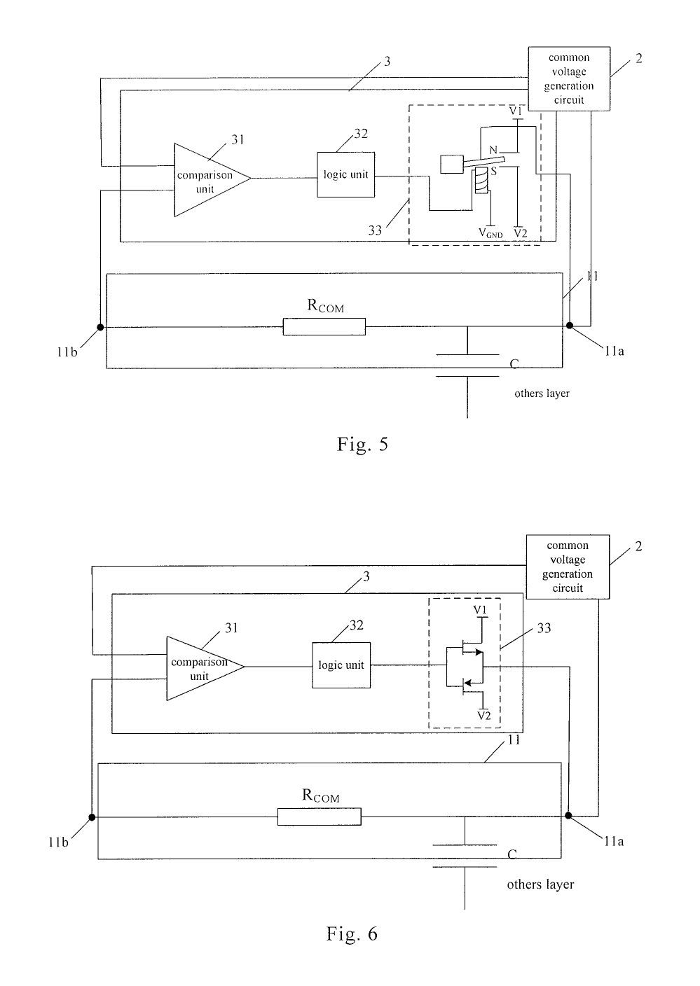

FIG. 5 is the second specific embodiment of the compensation unit in the common voltage compensation circuit according to the embodiments of the present invention. As shown in FIG. 5, the compensation unit 33 is a single-pole double throw electromagnetic relay configured to have two unmovable terminals, one movable terminal and one control signal input terminal, and its internal structure comprises: a first unmovable terminal, a second unmovable terminal, an armature connected with the movable terminal and an electromagnet. When a positive direction voltage is input to the electromagnet, the electromagnet generates a magnetic field and attracts the armature to contact with the first unmovable terminal, so that the first unmovable terminal is connected to the movable terminal; when a negative direction voltage is input to the electromagnet, the electromagnet generates a magnetic field having a opposite magnetism to that of the previous generated magnetic field and repels the armature to contact with the second unmovable terminal, so that the second unmovable terminal is connected to the movable terminal. Thus a single-pole double throw function is realized, wherein a magnet is disposed on the armature or the armature is made of the magnet. When specifically applying to the present embodiment, one of the two unmovable terminals in the relay is input the first level signal, the other is input the second level signal, the movable terminal is connected with the input terminal 11a of the common electrode 11, and the control signal input terminal is connected with the logic unit 32. The logic unit 32 outputs the positive direction voltage, the negative direction voltage and a 0 voltage.

FIG. 6 is the third specific embodiment of the compensation unit in the common voltage compensation circuit according to the embodiments of the present invention. As shown in FIG. 6, the compensation unit 33 comprises:

a N-type field effect transistor and a P-type field effect transistor forming a complementary symmetry structure;

the gates of the N-type field effect transistor and the P-type field effect transistor are both connected with the logic unit 32, an source (input terminal) of the N-type field effect transistor is input the first level signal V1, an source of the P-type field effect transistor is input the second level signal V2, and both of drains (output terminals) of the N-type field effect transistor and the P-type field effect transistor are connected with the common electrode.

Wherein the compensation control signal output from the logic unit 32 is any one of a first control signal, a second control signal and a third control signal. A voltage of the first control signal is higher than that of the first level signal V1, a voltage of the second control signal is lower than that of the first level signal V1, a voltage of the third control signal is greater than a difference between the reference common voltage Vref and a threshold voltage of the field effect transistor and is smaller than a sum of the reference common voltage Vref and the threshold voltage of the field effect transistor. The threshold voltage of the field effect transistor herein is the smaller one of those in the N-type field effect transistor and the P-type field effect transistor, that is, the threshold voltage of the N-type field effect transistor and the threshold voltage of the P-type field effect transistor are compared and the smaller one is selected. Briefly, the voltage of the third control signal is just such a magnitude that an effect of turning off the N-type field effect transistor and the P-type field effect transistor at the same time is achieved.

In particular, when the first level signal V1 provided to the common electrode by the compensation unit 33 is a direct current reference voltage V_{CC} and the second level signal V2 is a grounding signal V_{GND}, an operation process of the compensation circuit according the present embodiment is as follows.

The logic unit 32 outputs the compensation control signal according to the result of the comparison made by the comparison unit 31: the logic unit 32 output a high level when the actual common voltage at the common electrode is lower such that the deviation of the feedback voltage from the reference common voltage Vref exceeds the preset lower limit voltage value; the logic unit 32 output a low level when the actual common voltage at the common electrode is too high such that the deviation of the feedback voltage from the reference common voltage Vref exceeds the preset upper limit voltage value; and the logic unit 32 output 0 level when the actual common voltage at the common electrode is within a preset scope, that is, the deviation of the feedback voltage from the reference common voltage Vref neither exceeds the preset lower limit voltage value nor exceeds the preset upper limit voltage. Herein the high level is higher than a voltage value of the V_{CC} signal; the low level is lower than a voltage value of the V_{CC} signal and higher than 0V, and the 0 level is 0V.

The N-type field effect transistor and the P-type field effect transistor in the compensation unit 33 (hereinafter, referred to briefly as N-type transistor and P-type transistor) form a complementary symmetry structure and both operate in the saturation area. When the logic unit 32 outputs the high level (corresponding to a case where the actual common voltage is lower), since the high level output from the logic unit 32 is higher than the voltage value of the V_{CC} signal, the N-type transistor is turned on, and the V_{CC} signal charges the capacitor C via the N-type transistor to raise the voltage at the common electrode. At this time, the feedback voltage Vpanel increases correspondingly at this time. When it reaches a preset lower limit, the logic unit 32 outputs the 0 level (corresponding to the 0V), and then the N-type transistor and the P-type transistor are turned off at the same time. It can be seen that the voltage of the V_{CC} signal should be higher than the reference common voltage Vref so that the capacitor C is ensured to be charged to achieve the object of compensation when the actual common voltage is lower.

Similarly, when the logic unit 32 outputs the low level (corresponding to a case where the actual common voltage is too high), since the low level output from the logic unit 32 is lower than the voltage value of the V_{CC} signal and higher than 0V, the N-type transistor is turned off and the P-type transistor is turned on, the capacitor C is discharged, the common voltage decreases, and the feedback voltage Vpanel decreases correspondingly until it reaches a preset upper limit. At this time, the logic unit 32 outputs the 0 level, the N-type transistor and the P-type transistor are turned off at the same time. Also, the voltage of the second level signal V2 should be lower than the reference common voltage Vref so that the capacitor C is ensured to be discharged.

Herein, the N-type field effect transistor may also be connected to the second level signal V2 while the P-type field effect transistor may also be connected to the first level signal V1. However, at this time, the logic unit 32 correspondingly outputs the high level when the actual common voltage at the common electrode is lower, outputs the low level when the actual common voltage is too high, and outputs the 0 level when the actual common voltage is within the preset scope. The operation process of the compensation circuit is substantively similar.

Optionally, the compensation unit 33 may be implemented by triode, and because the way of implementation is substantively similar, details are omitted.

The compensation circuit according to the present embodiment does not require filtering circuit, has advantages of high compensation accuracy, less influence by environment, high reliability, etc, may obtain a more stable common voltage so as to improve the display effect of the liquid crystal display apparatus; at the same time, only some existing mature modules are needed to implement the compensation circuit, for example, the comparator, the logic elements and the like, so it is easy to be implemented and has low cost, which may facilitate to reduce the cost of the liquid crystal display apparatus.

The embodiments of the present invention further provide a liquid crystal display apparatus configured to comprise any one of the common voltage compensation circuits described in the above embodiment. Therefore, the common voltage is more stable, and thus phenomena such as a residual image, the abnormality of displaying gray scales, a crosstalk and the like caused by a shift of the common voltage are avoided, and the display effect is raised.

The display apparatus may be any product or components having a display function, such as, a liquid crystal panel, a E-paper, OLED panel, a mobile phone, a tablet PC, a TV, a display, a notebook computer, a digital photo frame, a navigation machine and the like.

Optionally, the first level signal V1 in the above-described embodiments may be an analog direct current power supply voltage V_{CC} or a digital direct current power supply voltage V_{DD}; and the second level signal V2 may be a grounding signal V_{GND}.

The technical features described in the above embodiments of the present invention may be combined with each other as long as there is no conflict.

The above are only exemplary embodiments of the invention, but the scope sought for protection is not limited thereto. Instead, any or all modifications or replacements as would be obvious to those skilled in the art are intended to be included within the technique scope of the present invention. Therefore, the protection scope of the present invention is defined in the appended claims.

What is claimed is:

1. A method for compensating a common voltage, comprising steps of:
comparing a feedback voltage with a reference common voltage output from a common voltage generation circuit and outputting a compared result, the feedback voltage being a common voltage acquired actually at a common electrode;
generating and outputting a compensation control signal according to the compared result; and
compensating the common voltage according to the compensation control signal.

2. The method of claim 1, wherein the step of generating a compensation control signal according to the compared result comprises:
generating the compensation control signal for providing a first level signal to the common electrode when the feedback voltage deviates from the reference common voltage by a value exceeding a preset lower limit voltage; and
generating the compensation control signal for providing a second level signal to the common electrode when the feedback voltage deviates from the reference common voltage by a value exceeding a preset upper limit voltage,
wherein the first level signal is greater than the reference common voltage, and the second level signal is smaller than the reference common voltage.

3. The method of claim 1, wherein the step of compensating the common voltage according to the compensation control signal comprises:
connecting the common electrode to the first level signal or the second level signal according to the compensation control signal, wherein the common electrode is charged such that the common voltage increases when the common electrode is connected to the first level signal, and the common electrode is discharged such that the common voltage decreases when the common electrode is connected to the second level signal.

4. A common voltage compensation circuit, configured to comprise two input terminals and one output terminal, the input terminals being connected with a common voltage generation circuit and common electrodes disposed on a liquid crystal panel, respectively, and the output terminal being also connected with the common electrode, comprising:
a comparison unit for receiving a feedback voltage and a reference common voltage output from the common voltage generation circuit, comparing the feedback voltage with the reference common voltage and outputting a compared result, the feedback voltage being a common voltage acquired actually at a common electrode;
a logic unit for generating and outputting a compensation control signal according to the compared result;
a compensation unit for receiving the compensation control signal output from the logic unit, and compensating the common voltage according to the compensation control signal.

5. The circuit of claim 4, wherein the logic unit is used to generate the compensation control signal for providing a first level signal to the common electrode when the feedback voltage deviates from the reference common voltage by a value exceeding a preset lower limit voltage; and generate the compensation control signal for providing a second level signal to the common electrode when the feedback voltage deviates from the reference common voltage by a value exceeding a preset upper limit voltage, wherein the first level signal is greater than the reference common voltage, and the second level signal is smaller than the reference common voltage.

6. The circuit of claim 4, wherein the compensation unit is used to connect the common electrode to the first level signal or the second level signal according to the compensation control signal, wherein the common electrode is charged such that the common voltage increases when the common electrode is connected to the first level signal, and the common electrode is discharged such that the common voltage decreases when the common electrode is connected to the second level signal.

7. The circuit of claim 4, wherein
the comparison unit comprises a window comparator or a basic comparator.

8. The circuit of claims 4, wherein the compensation unit is a data selector configured to have at least two input terminals, one output terminal and one control terminal;
one of the at least two input terminals is input the first level signal, and the other is input the second level signal, the output terminal is connected with the common electrode, and the control terminal is connected with the logic unit.

9. The circuit of claims 4, wherein the compensation unit is a single-pole double throw electromagnetic relay configured to have two unmovable terminals, one movable terminal and one control signal input terminal;
one of the two unmovable terminals is input the first level signal, and the other is input the second level signal, the movable terminal is connected with the common electrode, and the control signal input terminal is connected with the logic unit.

10. The circuit of claims 4, wherein the compensation unit comprises:
a N-type field effect transistor and a P-type field effect transistor forming a complementary symmetry structure;
wherein the gates of the N-type field effect transistor and the P-type field effect transistor are both connected with the logic unit, an input terminal of one of the N-type field effect transistor and the P-type field effect transistor is input the first level signal, an input terminal of the other is input the second level signal, and output terminals of the N-type field effect transistor and the P-type field effect transistor are both connected with the common electrode.

11. The circuit of claims 10, wherein the compensation control signal is any one of a first control signal, a second control signal and a third control signal,
wherein a voltage of the first control signal is higher than the first level signal, a voltage of the second control signal is lower than the first level signal, a voltage of the third control signal is greater than a difference between the reference common voltage and a threshold voltage of the field effect transistor and is smaller than a sum of the reference common voltage and the threshold voltage of the field effect transistor, and the threshold voltage of the field effect transistor is a smaller one of those in the N-type field effect transistor and the P-type field effect transistor.

12. A display apparatus comprising the common voltage compensation circuits of claim 4.
